(19) United States
(12) Patent Application Publication
(10) Pub. No.: US 2023/0198574 A1
(43) Pub. Date: Jun. 22, 2023

(54) TRANSMISSION SYSTEM

(71) Applicant: Murata Manufacturing Co., Ltd., Kyoto-fu (JP)

(72) Inventors: Tarou HIGUCHI, Nagaokakyo-shi (JP); Yoshihiro IMANISHI, Nagaokakyo-shi (JP); Yasushi SAITO, Nagaokakyo-shi (JP); Akio IGARASHI, Nagaokakyo-shi (JP); Hiroyuki HONDA, Nagaokakyo-shi (JP); Masaki INUI, Nagaokakyo-shi (JP); Minehito YOSHIDA, Nagaokakyo-shi (JP)

(73) Assignee: Murata Manufacturing Co., Ltd., Kyoto-fu (JP)

(21) Appl. No.: 18/169,736

(22) Filed: Feb. 15, 2023

Related U.S. Application Data
(63) Continuation of application No. PCT/JP2021/030893, filed on Aug. 24, 2021.

(30) Foreign Application Priority Data
Sep. 1, 2020 (JP) 2020-147093

(51) Int. Cl. H04B 3/56

(52) U.S. Cl. CPC H04B 3/56; H01B 11/12

(57) ABSTRACT

A transmission system capable of improving transmission characteristics in a low frequency range and having reduced size. A transmission system for superimposing power on a signal transmission path between a first circuit module and a second circuit module includes a first capacitor between the transmission path and a first interface IC in the first circuit module, a second capacitor between the transmission path and a second interface IC in the second circuit module, a first inductor between a first power supply circuit in the first circuit module and the transmission path, and a second inductor between a second power supply circuit in the second circuit module and the transmission path. A capacitance value of the first capacitor and a capacitance value of the second capacitor differ from each other. Inductance values of each of the first and second inductors are in a range from 20 [μH] to 50 [μH].

### CROSS-REFERENCE TO RELATED APPLICATIONS

This application claims benefit of priority to International Patent Application No. PCT/JP2021/030893, filed Aug. 24, 2021, and to Japanese Patent Application No. 2020-147093, filed Sep. 1, 2020, the entire contents of each are incorporated herein by reference.

### BACKGROUND

### Technical Field

The present disclosure relates to a transmission system.

### Background Art

In a transmission system in which signals are transmitted between, for example, an electronic control unit (ECU) and vehicle-mounted devices (loads) for enabling automatic driving of a vehicle, such as a light detection and ranging (LiDAR) system and a vehicle-mounted camera, the adoption of a transmission system such as power over coax (PoC) in which data transmission and power transmission are performed with a single coaxial cable or power over data lines (PoDL) with which differential data transmission and power transmission are enabled via a twisted wire pair has progressed in recent years for reduction in weight and cost of a wire harness, as described, for example, in Japanese Patent No. 6202704.

### SUMMARY

In a transmission system such as PoC or PoDL, so-called bias-T circuits are provided at both ends of a coaxial cable or a transmission line such as a wire including a twisted wire pair. The bias-T circuits are provided between a data line that flows a signal and a power supply circuit and superimpose a direct component (direct voltage or a direct current) on the data line. Each of the bias-T circuits includes a coupling capacitor provided in series to the transmission line and an inductor provided between the data line and the power supply circuit. Thus, the bias-T circuits are configured to prevent a transmission target signal from entering the power supply circuit in the transmission system.

In such a transmission system, the bias-T circuits located at both ends of the transmission line generally have the same configuration. Although a method of increasing the inductance value of the bias-T circuit is considered to improve transmission characteristics in a low frequency range, the size of an inductor component having a large inductance value is generally large and an interface IC for enabling the SerDes transmission system may therefore increase in size. If an inductor of a small size is used for reduction in size of the interface IC, the rated current value of the interface IC decreases and the scope of application of connection target devices may be narrowed.

The present disclosure has been made in view of the above-described situations, and thus provides a transmission system with which transmission characteristics in a low frequency range can be improved and size reduction can be achieved.

A transmission system according to an aspect of the present disclosure is configured to superimpose power on a transmission path for a signal between a first circuit module and a second circuit module. The transmission system includes a first capacitor provided between the transmission path and a first interface IC in the first circuit module, a second capacitor provided between the transmission path and a second interface IC in the second circuit module, a first inductor provided between a first power supply circuit in the first circuit module and the transmission path, and a second inductor provided between a second power supply circuit in the second circuit module and the transmission path. A capacitance value of the first capacitor and a capacitance value of the second capacitor differ from each other. An inductance value of the first inductor and an inductance value of the second inductor are in a range from 20 [μH] to 50 [μH].

With this configuration, transmission characteristics in a low frequency range can be improved and size reduction can be achieved.

According to the present disclosure, a circuit module and a network module which are capable of performing noise control suitable for a connection target device can be provided.

### BRIEF DESCRIPTION OF THE DRAWINGS

FIG. 1 is a diagram illustrating the schematic configuration of a transmission system according to Embodiment 1;

FIG. 2A is a diagram illustrating the equivalent circuit of a transmission circuit according to Embodiment 1;

FIG. 2B is a schematic diagram illustrating the equivalent circuit in FIG. 2A in a simplified manner;

FIG. 3 is a diagram illustrating simulation patterns of the transmission system according to Embodiment 1;

FIG. 4A is a diagram illustrating simulation results of reflection characteristics of a first port in simulation patterns A, B, and C illustrated in FIG. 3;

FIG. 4B is a diagram illustrating simulation results of reflection characteristics of a second port in the simulation patterns A, B, and C illustrated in FIG. 3;

FIG. 4C is a diagram illustrating simulation results of bandpass characteristics from the first port to the second port in the simulation patterns A, B, and C illustrated in FIG. 3;

FIG. 5A is a diagram illustrating simulation results of reflection characteristics of the first port in the simulation patterns A, B, and C illustrated in FIG. 3 when a transmission line length is 10 [m];

FIG. 5B is a diagram illustrating simulation results of reflection characteristics of the second port in the simulation patterns A, B, and C illustrated in FIG. 3 when a transmission line length is 10 [m];

FIG. 5C is a diagram illustrating simulation results of bandpass characteristics from the first port to the second port in the simulation patterns A, B, and C illustrated in FIG. 3 when a transmission line length is 10 [m];

FIG. 6A is a diagram illustrating simulation results of reflection characteristics of the first port in the simulation patterns A, B, and C illustrated in FIG. 3 when a transmission line length is 2 [m];

FIG. 6B is a diagram illustrating simulation results of reflection characteristics of the second port in the simulation patterns A, B, and C illustrated in FIG. 3 when a transmission line length is 2 [m];

FIG. 6C is a diagram illustrating simulation results of bandpass characteristics from the first port to the second port in the simulation patterns A, B, and C illustrated in FIG. 3 when a transmission line length is 2 [m];

FIG. 7 is a diagram illustrating simulation results of reflection characteristics of the first port in simulation patterns C, D, and E illustrated in FIG. 3;

FIG. 8 is a diagram illustrating a simulation result of reflection characteristics of the first port in a simulation pattern F illustrated in FIG. 3;

FIG. 9 is a diagram illustrating simulation results of reflection characteristics of the first port in simulation patterns G, H, and I illustrated in FIG. 3;

FIG. 10 is a diagram illustrating simulation results of reflection characteristics of the first port in simulation patterns C, J, K, and L illustrated in FIG. 3;

FIG. 11A is a diagram illustrating simulation results of reflection characteristics of the first port in simulation patterns C and M illustrated in FIG. 3;

FIG. 11B is a diagram illustrating simulation results of reflection characteristics of the second port in the simulation patterns C and M illustrated in FIG. 3;

FIG. 12 is a diagram illustrating simulation results of reflection characteristics of the first port in simulation patterns C, N, O, and P illustrated in FIG. 3; and

FIG. 13 is a diagram illustrating the schematic configuration of a transmission system according to Embodiment 2.

### DETAILED DESCRIPTION

Transmission systems according to embodiments will be described in detail below with reference to the accompanying drawings. It is to be noted that the present disclosure is not limited to the embodiments. The embodiments are illustrative, and, needless to say, a partial replacement or combination of configurations described in the different embodiments is possible. In the second and subsequent embodiments, descriptions of matters common to those in Embodiment 1 will be omitted and only different points will be described. In particular, descriptions of similar advantageous effects obtained with similar configurations will not be repeated in each of the embodiments.

### Embodiment 1

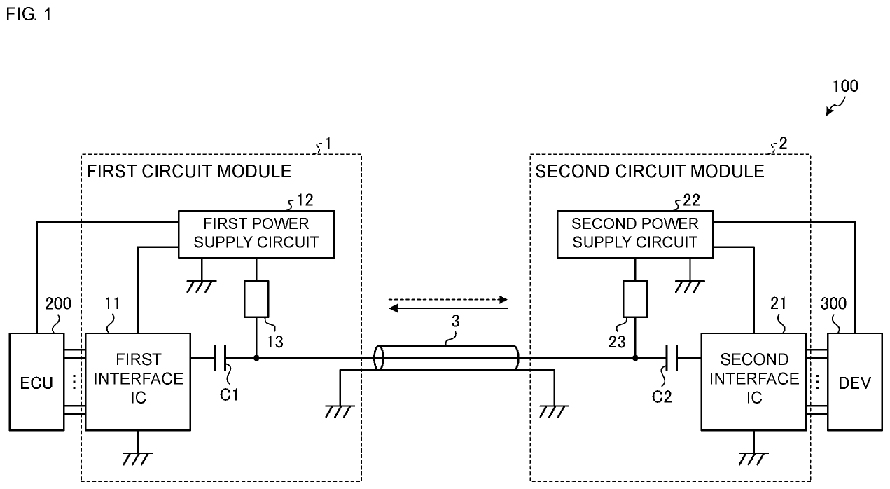

FIG. 1 is a diagram illustrating the schematic configuration of a transmission system according to Embodiment 1.

A transmission system 100 according to the present embodiment enables an interface between a vehicle-mounted device (hereinafter also referred to as “DEV”) 300 such as a vehicle-mounted camera that is a connection target device and an electronic control unit (hereinafter also referred to as “ECU”) 200 by using, for example, the SerDes transmission system. Specifically, in the transmission system 100, signals are transmitted between a first circuit module 1 and a second circuit module 2 that are connected via a coaxial cable 3 as illustrated in FIG. 1.

The transmission system 100 enables PoC (Power over Coax) in which a direct voltage is applied to a signal transmission path and power is supplied to the DEV 300 via the coaxial cable 3.

In the example illustrated in FIG. 1, the first circuit module 1 includes a first interface IC 11, a first power supply circuit (power supply circuit) 12, and a PoC circuit 13 as constituent elements according to the present embodiment. The second circuit module 2 includes a second interface IC 21, a second power supply circuit 22, and a PoC circuit 23 as constituent elements according to the present embodiment. Each of the PoC circuit 13 and the PoC circuit 23 includes at least an inductor.

The first interface IC 11 converts a signal input from the ECU 200 and outputs the converted signal to the second circuit module 2 via the coaxial cable 3. The first interface IC 11 converts a signal input via the coaxial cable 3 and outputs the converted signal to the ECU 200.

The second interface IC 21 converts a signal input from the DEV 300 and outputs the converted signal to the first circuit module 1 via the coaxial cable 3. The second interface IC 21 converts a signal input via the coaxial cable 3 and outputs the converted signal to the DEV 300.

Referring to FIG. 1, a transmission direction of a signal from the first interface IC 11 to the second interface IC 21 is represented by a broken arrow. A signal transmission path from the second interface IC 21 to the first interface IC 11 is represented by a solid arrow.

The first power supply circuit 12 supplies power to, for example, the first interface IC 11 and the ECU 200 and also supplies power to the signal transmission path via the PoC circuit 13. The second power supply circuit 22 receives power supplied from the signal transmission path via the PoC circuit 23 and supplies power to, for example, the second interface IC 21 and the DEV 300.

In the present embodiment, it is assumed that the transmission speed of a signal from the first interface IC 11 to the second interface IC 21 is lower than that of a signal from the second interface IC 21 to the first interface IC 11. Specifically, it is assumed that the transmission speed of a signal from the first interface IC 11 to the second interface IC 21 is relatively low in the range from, for example, 1 [MHz] to several tens of [MHz]. It is assumed that the transmission speed of a signal from the second interface IC 21 to the first interface IC 11 is relatively high in the range from, for example, several hundreds of [MHz] to several thousands of [MHz].

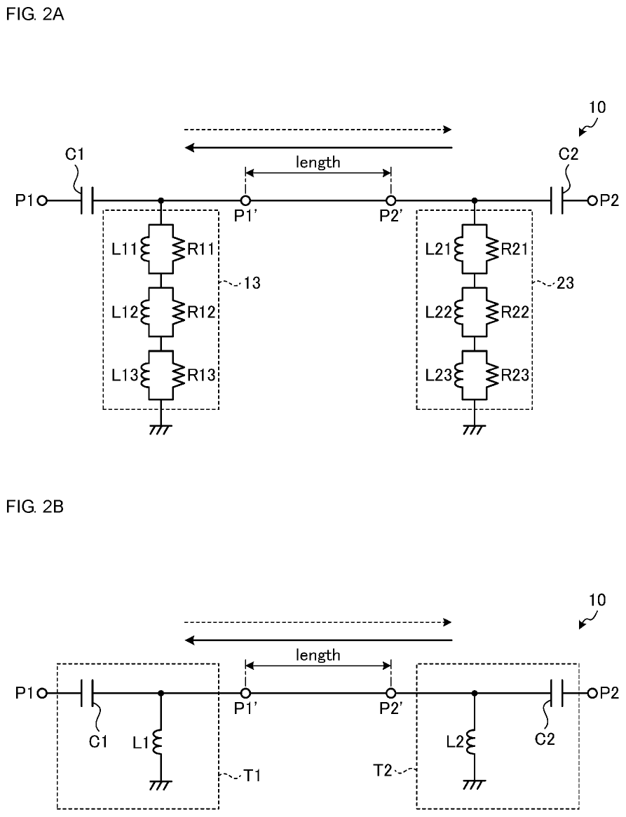

FIG. 2A is a diagram illustrating the equivalent circuit of a transmission circuit according to Embodiment 1. FIG. 2B is a schematic diagram illustrating the equivalent circuit in FIG. 2A in a simplified manner.

As illustrated in FIG. 2A, a transmission circuit 10 according to Embodiment 1 includes a transmission line P1′-P2′ provided between a first port P1 and a second port P2, a first capacitor C1 provided between the first port P1 and the transmission line P1′-P2′, a second capacitor C2 provided between the second port P2 and the transmission line P1′-P2′, the PoC circuit 13 connected in shunt with a node between the first capacitor C1 and the transmission line P1′-P2′, and the PoC circuit 23 connected in shunt with a node between the second capacitor C2 and the transmission line P1′-P2′.

In the example illustrated in FIG. 2A, for example, a parallel circuit of an inductor L11 and a resistor R11, a parallel circuit of an inductor L12 and a resistor R12, and a parallel circuit of an inductor L13 and a resistor R13 are connected in series in the PoC circuit 13. An end portion of the PoC circuit 13 is connected to the first power supply circuit (power supply circuit) 12 as illustrated in FIG. 1, but FIG. 2A illustrates the configuration as the equivalent circuit in which the end portion of the PoC circuit 13 is connected to a GND potential.

The PoC circuit 13 can be simplified as a first inductor L1 as illustrated in FIG. 2B. The first capacitor C1 and the first inductor L1 form a first bias-T circuit T1. In the present disclosure, the resistors R11, R12, and R13 illustrated in FIG. 2A are omitted (opened) as illustrated in FIG. 2B at the time of simulations to be described below.

In the example illustrated in FIG. 2A, for example, a parallel circuit of an inductor L21 and a resistor R21, a parallel circuit of an inductor L22 and a resistor R22, and a parallel circuit of an inductor L23 and a resistor R23 are connected in series in the PoC circuit 23. An end portion of the PoC circuit 23 is connected to the second power supply circuit (power supply circuit) 22 as illustrated in FIG. 1, but FIG. 2A illustrates the configuration as the equivalent circuit in which the end portion of the PoC circuit 23 is connected to a GND potential.

The PoC circuit 23 can be simplified as a second inductor L2 as illustrated in FIG. 2B. The second capacitor C2 and the second inductor L2 form a second bias-T circuit T2. In the present disclosure, the resistors R21, R22, and R23 illustrated in FIG. 2A are omitted (opened) as illustrated in FIG. 2B at the time of simulations to be described below.

Referring to FIGS. 2A and 2B, the first port P1 corresponds to a signal input/output terminal of the first interface IC 11 and the second port P2 corresponds to a signal input/output terminal of the second interface IC 21. The transmission line P1′-P2′ corresponds to the coaxial cable 3, a port P1′ corresponds to a signal input/output terminal of the first circuit module 1, and a port P2′ corresponds to a signal input/output terminal of the second circuit module 2.

The respective capacitance values of the first capacitor C1 and the second capacitor C2, and the respective inductance values of the first inductor L1 and the second inductor L2 in the transmission system 100 according to Embodiment 1 will be described below with reference to simulation results.

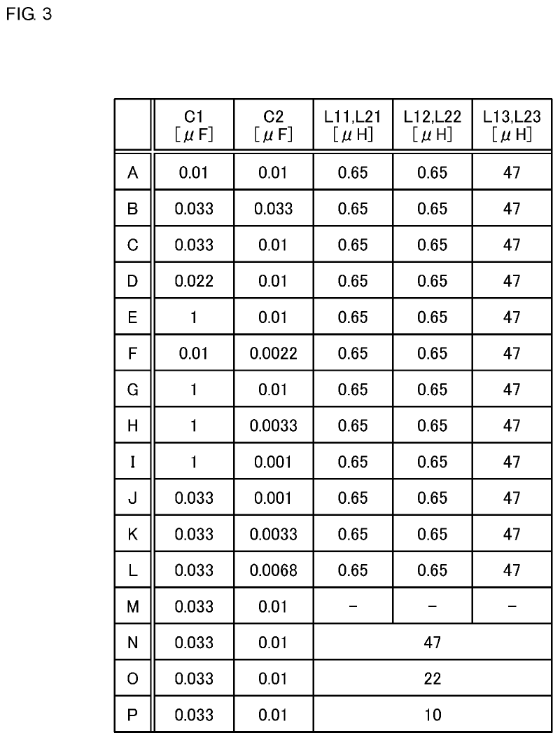

FIG. 3 is a diagram illustrating simulation patterns of the transmission system according to Embodiment 1. Descriptions will be made below with reference to the simulation patterns illustrated in FIG. 3 as appropriate. The simulation results will be described on the assumption that the length of the transmission line P1′-P2′, that is, the length of the coaxial cable 3, (hereinafter also referred to simply as “transmission line length”) is 15 [m] unless otherwise noted.

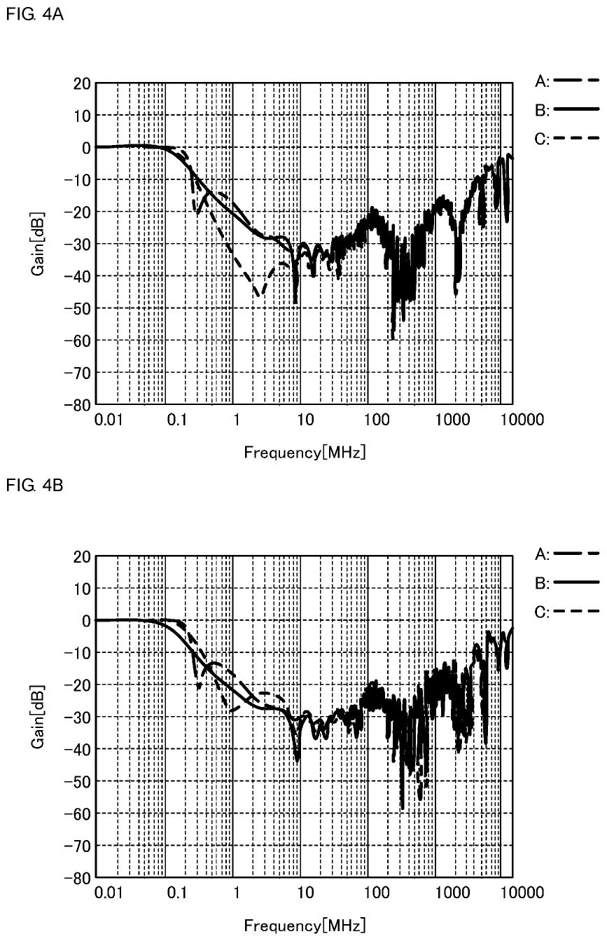

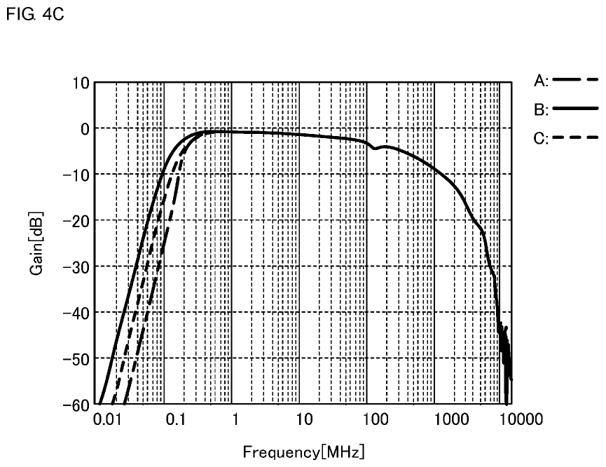

FIG. 4A is a diagram illustrating simulation results of reflection characteristics of the first port in simulation patterns A, B, and C illustrated in FIG. 3. FIG. 4B is a diagram illustrating simulation results of reflection characteristics of the second port in the simulation patterns A, B, and C illustrated in FIG. 3. FIG. 4C is a diagram illustrating simulation results of bandpass characteristics from the first port to the second port in the simulation patterns A, B, and C illustrated in FIG. 3.

Referring to FIGS. 4A, 4B, and 4C, the horizontal axis represents frequency and the vertical axis represents gain. Referring to FIGS. 4A, 4B, and 4C, a dash-dot line represents the simulation result of the pattern A illustrated in FIG. 3, a solid line represents the simulation result of the pattern B illustrated in FIG. 3, and a broken line represents the simulation result of the pattern C illustrated in FIG. 3.

As illustrated in FIG. 3, the first capacitor C1 has 0.01 [μF], the second capacitor C2 has 0.01 [μF], the inductor L11 in the first inductor L1 and the inductor L21 in the second inductor L2 have 0.65 [μH], the inductors L12 and L22 have 0.65 [μH], and the inductors L13 and L23 have 47 [μH] in the pattern A.

As illustrated in FIG. 3, the first capacitor C1 has 0.033 [μF] and the second capacitor C2 has 0.033 [μF] in the pattern B. The inductors L11, L12, and L13 in the first inductor L1 and the inductors L21, L22, and L23 in the second inductor L2 have the same respective values as those in the pattern A.

As illustrated in FIG. 3, the first capacitor C1 has 0.033 [μF] and the second capacitor C2 has 0.01 [μF] in the pattern C. The inductors L11, L12, and L13 in the first inductor L1 and the inductors L21, L22, and L23 in the second inductor L2 have the same respective values as those in the pattern A.

In the present disclosure, in transmission characteristics in which a parallel signal is transmitted from the first interface IC 11 side to the second interface IC 21 side, that is, from the first port P1 to the second port P2 illustrated in FIGS. 2A and 2B, at the transmission speed of 1 [MHz] to several tens of [MHz], reflection characteristics on the first interface IC 11 side, that is, at the first port P1, are particularly improved. Specifically, reflection characteristics on the first interface IC 11 side, that is, at the first port P1, at frequencies of 1 [MHz] to 10 [MHz] are focused. As a criterion for determination of reflection characteristics, a frequency range in which gains less than or equal to −30 [dB] are obtained at frequencies of 1 [MHz] to 10 [MHz] is focused.

The first bias-T circuit T1 and the second bias-T circuit T2 are generally the same. When the inductance values of the first inductor L1 (the inductors L11, L12, and L13) in the PoC circuit 13 and the second inductor L2 (the inductors L21, L22, and L23) in the PoC circuit 23 are increased, transmission characteristics in a relatively low frequency range can be improved. However, the increase in the inductance values of the first inductor L1 (the inductors L11, L12, and L13) and the second inductor L2 (the inductors L21, L22, and L23) may lead to the increase in the sizes of the first circuit module 1 and the second circuit module 2. When the first inductor L1 (the inductors L11, L12, and L13) and the second inductor L2 (the inductors L21, L22, and L23) are reduced in size for reduction in the circuit sizes of the first circuit module 1 and the second circuit module 2, the value of a rated current that can flow through the signal transmission path in the transmission system 100 is reduced.

Accordingly, transmission characteristics in a relatively low frequency range are improved by optimizing the capacitance values of the first capacitor C1 in the first bias-T circuit T1 and the second capacitor C2 in the second bias-T circuit T2 in the present disclosure.

Specifically, for example, the pattern B in which the first capacitor C1 has 0.033 [μF] and the second capacitor C2 has 0.033 [μF] has the low-pass characteristics from the first port P1 to the second port P2 which are better than those of the pattern A in which the first capacitor C1 has 0.01 [μF] and the second capacitor C2 has 0.01 [μF] as illustrated in FIG. 4C.

On the other hand, reflection characteristics at the first port P1 at frequencies of 1 [MHz] to 10 [MHz] are not significantly improved as illustrated in FIG. 4A. That is, it is difficult to improve reflection characteristics at the first port P1 at frequencies of 1 [MHz] to 10 [MHz] even if the capacitance values of the first capacitor C1 and the second capacitor C2 are increased to the same value.

In contrast, reflection characteristics at the first port P1 at frequencies of 1 [MHz] to 10 [MHz] are significantly improved as represented by the broken line in FIG. 4A in the pattern C illustrated in FIG. 3 in which the first capacitor C1 has 0.033 [μF] and the second capacitor C2 has 0.01 [μF]. That is, in the reflection characteristics at frequencies of 1 [MHz] to 10 [MHz] focused in the present disclosure, the simulation results of reflection characteristics of the first port (FIG. 4A) show that the pattern C has the broader frequency range in which gains less than or equal to −30 [dB] are obtained than the patterns A and B. That is, in the reflection characteristics at frequencies of 1 [MHz] to 10 [MHz] focused in the present disclosure, the simulation result of the pattern C is best.

As illustrated in FIG. 4C, the pattern C in which the first capacitor C1 has 0.033 [μF] and the second capacitor C2 has 0.01 [μF] has low-pass characteristics from the first port P1 to the second port P2 which are not better than those of the pattern B in which the first capacitor C1 has 0.033 [μF] and the second capacitor C2 has 0.033 [μF] but better than those of the pattern Ain which the first capacitor C1 has 0.01 [μF] and the second capacitor C2 has 0.01 [μF].

Thus, the reflection characteristics at frequencies of 1 [MHz] to 10 [MHz] focused in the present disclosure can be improved with the pattern C illustrated in FIG. 3, that is, by setting the capacitance value of the first capacitor C1 to 0.033 [μF] and the capacitance value of the second capacitor C2 to 0.01 [μF].

The possible reason why the good simulation result of reflection characteristics of the first port (FIG. 4A) is obtained in the pattern C in which the first capacitor C1 has 0.033 [μF] and the second capacitor C2 has 0.01 [μF] is that the ESL of a capacitor and the parasitic inductance of a cable affect each other because the transmission line length is 15 [m] which is relatively long.

Next, results of simulations conducted for different transmission line lengths will be described below.

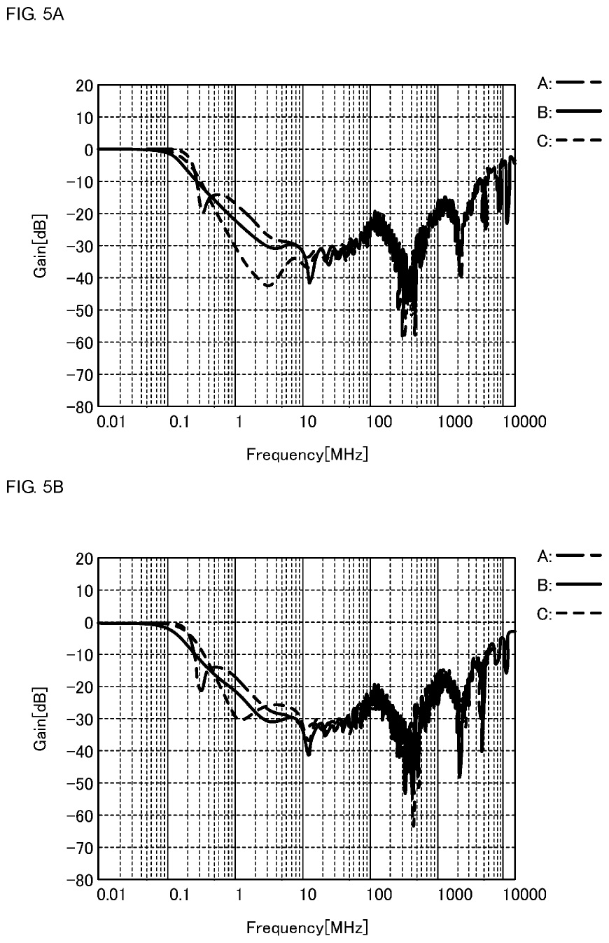

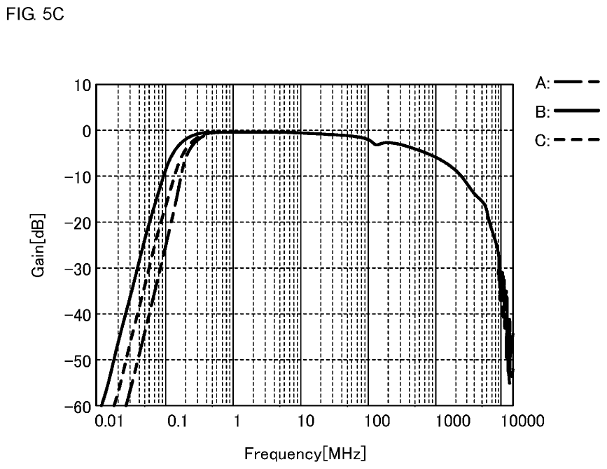

FIG. 5A is a diagram illustrating simulation results of reflection characteristics of the first port in the simulation patterns A, B, and C illustrated in FIG. 3 when a transmission line length is 10 [m]. FIG. 5B is a diagram illustrating simulation results of reflection characteristics of the second port in the simulation patterns A, B, and C illustrated in FIG. 3 when a transmission line length is 10 [m]. FIG. 5C is a diagram illustrating simulation results of bandpass characteristics from the first port to the second port in the simulation patterns A, B, and C illustrated in FIG. 3 when a transmission line length is 10 [m].

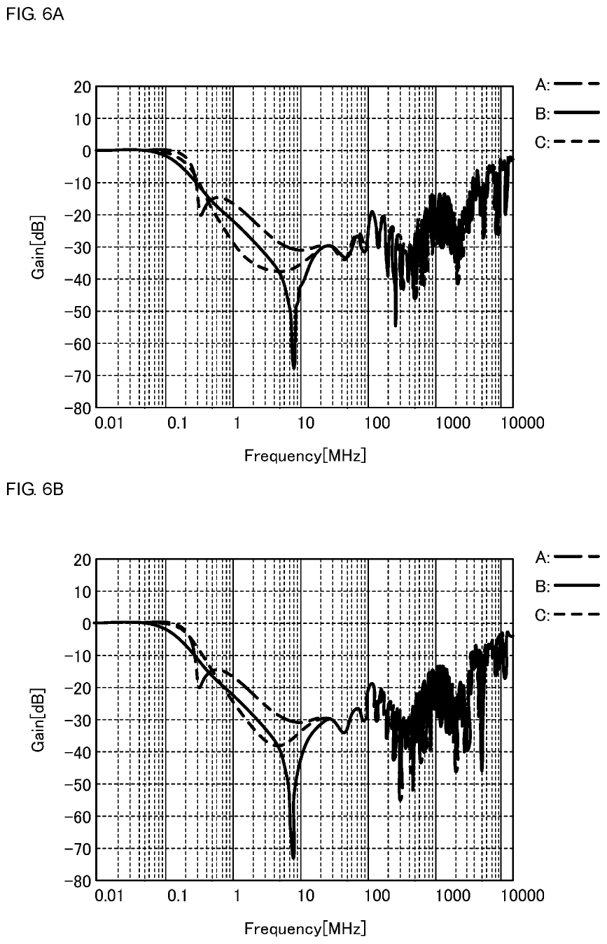

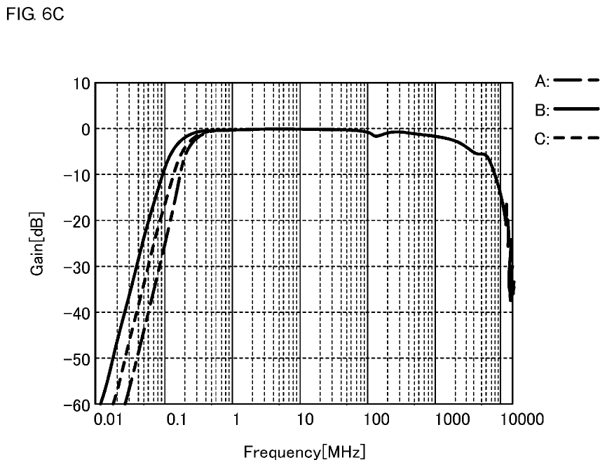

FIG. 6A is a diagram illustrating simulation results of reflection characteristics of the first port in the simulation patterns A, B, and C illustrated in FIG. 3 when a transmission line length is 2 [m]. FIG. 6B is a diagram illustrating simulation results of reflection characteristics of the second port in the simulation patterns A, B, and C illustrated in FIG. 3 when a transmission line length is 2 [m]. FIG. 6C is a diagram illustrating simulation results of bandpass characteristics from the first port to the second port in the simulation patterns A, B, and C illustrated in FIG. 3 when a transmission line length is 2 [m].

Referring to FIGS. 5A, 5B, 5C, 6A, 6B, and 6C, the horizontal axis represents frequency and the vertical axis represents gain. Referring to FIGS. 5A, 5B, 5C, 6A, 6B, and 6C, a dash-dot line represents the simulation result of the pattern A illustrated in FIG. 3, a solid line represents the simulation result of the pattern B illustrated in FIG. 3, and a broken line represents the simulation result of the pattern C illustrated in FIG. 3.

It is apparent from the simulation results in FIGS. 5A, 5B, and 5C when the transmission line length is 10 [m] that transmission characteristics do not significantly differ from the transmission characteristics illustrated in FIGS. 4A, 4B, and 4C when the transmission line length is 15 [m].

On the other hand, it is apparent from the simulation results in FIGS. 6A, 6B, and 6C when the transmission line length is 2 [m] that transmission characteristics significantly differ from the transmission characteristics illustrated in FIGS. 4A, 4B, and 4C when the transmission line length is 15 [m] and the transmission characteristics illustrated in FIGS. 5A, 5B, and 5C when the transmission line length is 10 [m]. Specifically, in the case of the pattern C, there is not a significant difference between the simulation result (FIG. 6A) of reflection characteristics of the first port and the simulation result (FIG. 6B) of reflection characteristics of the second port. In the reflection characteristics at frequencies of 1 [MHz] to 10 [MHz] focused in the present disclosure, both the simulation results (FIG. 6A) of reflection characteristics of the first port and the simulation results (FIG. 6B) of reflection characteristics of the second port show that the pattern C has the broader frequency range in which gains less than or equal to −30 [dB] are obtained than the patterns A and B. That is, in the reflection characteristics at frequencies of 1 [MHz] to 10 [MHz] focused in the present disclosure, the simulation result of the pattern C is best.

Accordingly, instead of using the pattern C illustrated in FIG. 3 in which the first capacitor C1 has 0.033 [μF] and the second capacitor C2 has 0.01 [μF], the first capacitor C1 may have 0.01 [μF] and the second capacitor C2 may have 0.033 [μF].

For any one of the transmission directions represented by the broken line and the solid line in FIG. 1 (and FIGS. 2A and 2B), a relatively low transmission speed of 1 [MHz] to several tens of [MHz] may be set. That is, the transmission speed of a signal from the first interface IC 11 to the second interface IC 21 may be a relatively low transmission speed of 1 [MHz] to several tens of [MHz], or the transmission speed of a signal from the second interface IC 21 to the first interface IC 11 may be a relatively low transmission speed of 1 [MHz] to several tens of [MHz].

Alternatively, for both the transmission directions represented by the broken line and the solid line in FIG. 1 (and FIGS. 2A and 2B), a relatively low transmission speed of 1 [MHz] to several tens of [MHz] may be set. That is, both the transmission speed of a signal from the first interface IC 11 to the second interface IC 21 and the transmission speed of a signal from the second interface IC 21 to the first interface IC 11 may be a relatively low transmission speed of 1 [MHz] to several tens of [MHz].

Next, results of simulations conducted for different capacitance values of the first capacitor C1 will be described below.

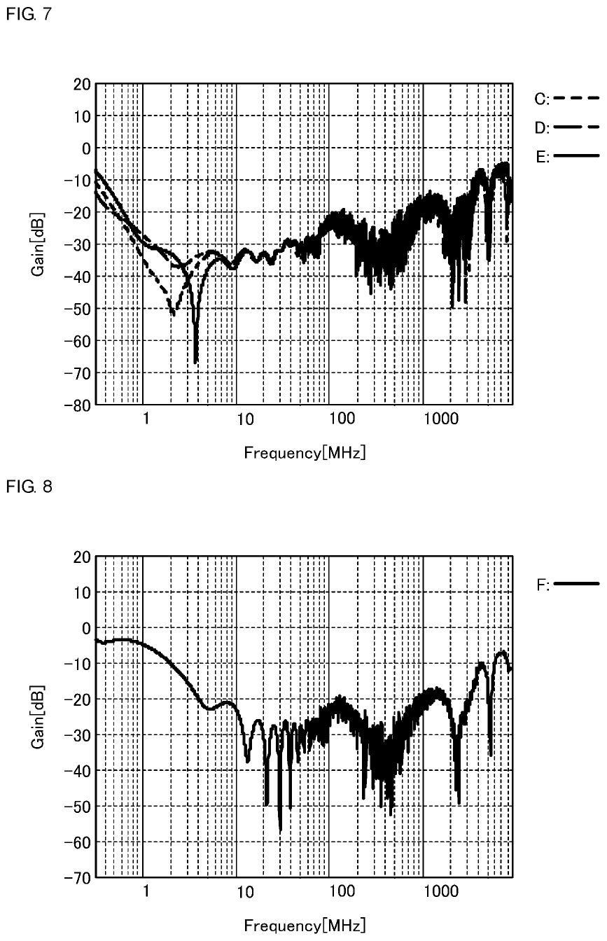

FIG. 7 is a diagram illustrating simulation results of reflection characteristics of the first port in simulation patterns C, D, and E illustrated in FIG. 3. FIG. 8 is a diagram illustrating a simulation result of reflection characteristics of the first port in a simulation pattern F illustrated in FIG. 3.

Referring to FIGS. 7 and 8, the horizontal axis represents frequency and the vertical axis represents gain. Referring to FIG. 7, a broken line represents the simulation result of the pattern C illustrated in FIG. 3, a dash-dot line represents the simulation result of the pattern D illustrated in FIG. 3, a solid line represents the simulation result of the pattern E illustrated in FIG. 3.

As illustrated in FIG. 3, the first capacitor C1 has 0.022 [μF] in the pattern D. The second capacitor C2, the inductors L11, L12, and L13 included in the first inductor L1, and the inductors L21, L22, and L23 included in the second inductor L2 have the same respective values as those in the pattern C.

As illustrated in FIG. 3, the first capacitor C1 has 1 [μF] in the pattern E. The second capacitor C2, the inductors L11, L12, and L13 included in the first inductor L1, and the inductors L21, L22, and L23 included in the second inductor L2 have the same respective values as those in the pattern C.

As illustrated in FIG. 3, the first capacitor C1 has 0.01 [μF] and the second capacitor C2 has 0.0022 [μF] in the pattern F. The inductors L11, L12, and L13 included in the first inductor L1 and the inductors L21, L22, and L23 included in the second inductor L2 have the same respective values as those in the pattern C.

As illustrated in FIG. 7, in the reflection characteristics at frequencies of 1 [MHz] to 10 [MHz] focused in the present disclosure, the gain of approximately −30 [dB] is obtained as represented by the dash-dot line in FIG. 7 in the pattern D illustrated in FIG. 3 in which the first capacitor C1 has 0.022 [μF].

On the other hand, in the reflection characteristics at frequencies of 1 [MHz] to 10 [MHz] focused in the present disclosure, a frequency range in which the gain of −30 [dB] is obtained is limited to a frequency range of approximately 6 [MHz] or higher in the pattern A illustrated in FIG. 3 in which the first capacitor C1 has 0.01 [μF] (see FIG. 4A).

As illustrated in FIG. 7, in the reflection characteristics at frequencies of 1 [MHz] to 10 [MHz] focused in the present disclosure, the gain of −30 [dB] is also obtained as represented by the solid line in FIG. 7 in the pattern E illustrated in FIG. 3 in which the first capacitor C1 has 1 [μF]. In the transmission system 100 illustrated in FIG. 1, it is not assumed that the first capacitor C1 has a capacitance value greater than or equal to 1 [μF]. It is not desired that the capacitance value of the first capacitor C1 be increased from the viewpoint of space saving.

On the other hand, as illustrated in FIG. 8, in the reflection characteristics at frequencies of 1 [MHz] to 10 [MHz] focused in the present disclosure, a frequency range in which the gain of −30 [dB] is obtained is not included in the pattern F illustrated in FIG. 3 in which the first capacitor C1 has 0.01 [μF] and the second capacitor C2 has 0.0022 [μF].

Accordingly, it is desired that the capacitance value of the first capacitor C1 be greater than or equal to 0.022 [μF].

Next, results of simulations conducted for different capacitance values of the second capacitor C2 will be described below.

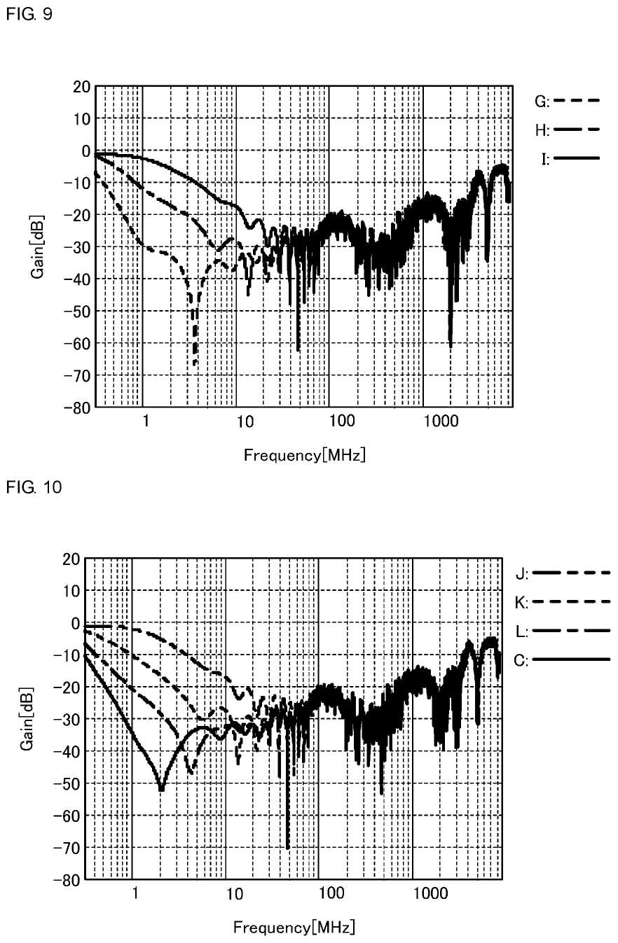

FIG. 9 is a diagram illustrating simulation results of reflection characteristics of the first port in simulation patterns G, H, and I illustrated in FIG. 3. FIG. 10 is a diagram illustrating simulation results of reflection characteristics of the first port in simulation patterns C, J, K, and L illustrated in FIG. 3.

Referring to FIGS. 9 and 10, the horizontal axis represents frequency and the vertical axis represents gain. Referring to FIG. 9, a broken line represents the simulation result of the pattern G illustrated in FIG. 3, a dash-dot line represents the simulation result of the pattern H illustrated in FIG. 3, a solid line represents the simulation result of the pattern I illustrated in FIG. 3. Referring to FIG. 10, a solid line represents the simulation result of the pattern C illustrated in FIG. 3, a dash-dot-dot line represents the simulation result of the pattern J illustrated in FIG. 3, a broken line represents the simulation result of the pattern K illustrated in FIG. 3, and a dash-dot line represents the simulation result of the pattern L illustrated in FIG. 3.

As illustrated in FIG. 3, the first capacitor C1 has 1 [μF] in the patterns G, H, and I. The inductors L11, L12, and L13 included in the first inductor L1 and the inductors L21, L22, and L23 included in the second inductor L2 have the same respective values as those in the pattern C.

The second capacitor C2 has 0.01 [μF] in the pattern G, has 0.0033 [μF] in the pattern H, and has 0.001 [μF] in the pattern I.

As illustrated in FIG. 3, the first capacitor C1 has 0.033 [μF] in the patterns J, K, and L. The inductors L11, L12, and L13 included in the first inductor L1 and the inductors L21, L22, and L23 included in the second inductor L2 have the same respective values as those in the pattern C.

The second capacitor C2 has 0.001 [μF] in the pattern J, has 0.0033 [μF] in the pattern K, and has 0.0068 [μF] in the pattern L.

FIG. 9 illustrates the case where the first capacitor C1 has 1 [μF] assumed in the transmission system 100 illustrated in FIG. 1. In the reflection characteristics at frequencies of 1 [MHz] to 10 [MHz] focused in the present disclosure, the gain of −30 [dB] is obtained in the pattern Gin which the second capacitor C2 has 0.01 [μF]. However, in the reflection characteristics at frequencies of 1 [MHz] to 10 [MHz] focused in the present disclosure, a frequency range in which the gain of −30 [dB] is obtained is limited to a frequency range from approximately 5 [MHz] to approximately 7 [MHz] in the pattern H in which the second capacitor C2 has 0.0033 [μF]. In the reflection characteristics at frequencies of 1 [MHz] to 10 [MHz] focused in the present disclosure, a frequency range in which the gain of −30 [dB] is obtained is not included in the pattern I in which the second capacitor C2 has 0.001 [μF].

On the other hand, FIG. 10 illustrates the case where the first capacitor C1 has 0.033 [μF] that is the same value in the pattern C. In the reflection characteristics at frequencies of 1 [MHz] to 10 [MHz] focused in the present disclosure, a frequency range in which the gain of −30 [dB] is obtained is limited to a frequency range of approximately 2 [MHz] or higher in the pattern L in which the second capacitor C2 has 0.0068 [μF]. However, in the reflection characteristics at frequencies of 1 [MHz] to 10 [MHz] focused in the present disclosure, a frequency range in which the gain of −30 [dB] is obtained is limited to a frequency range from approximately 5 [MHz] to approximately 6 [MHz] in the pattern K in which the second capacitor C2 has 0.0033 [μF]. In the reflection characteristics at frequencies of 1 [MHz] to 10 [MHz] focused in the present disclosure, a frequency range in which the gain of −30 [dB] is obtained is not included in the pattern J in which the second capacitor C2 has 0.001 [μF].

Accordingly, it is desired that the capacitance value of the second capacitor C2 be in the range from 0.0068 [μF] to 0.01 [μF].

Next, results of simulations conducted for different inductance values of the first inductor L1 and the second inductor L2 will be described below.

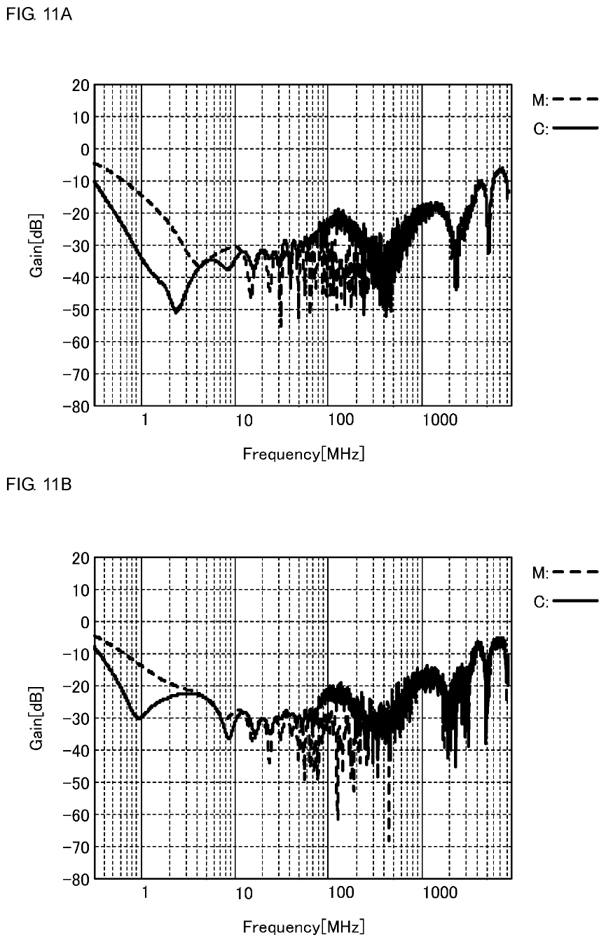

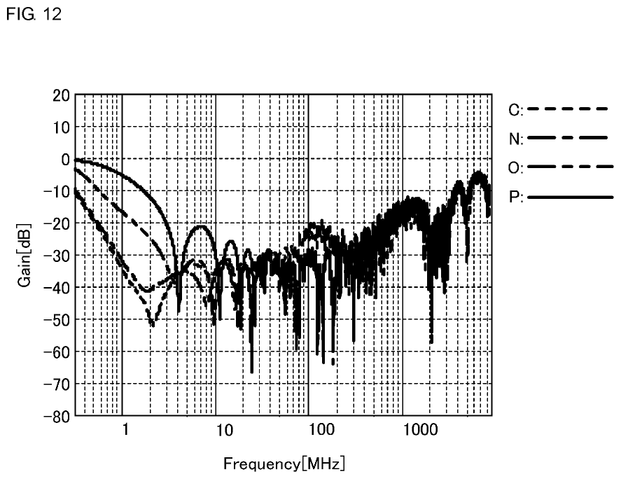

FIG. 11A is a diagram illustrating simulation results of reflection characteristics of the first port in simulation patterns C and M illustrated in FIG. 3. FIG. 11B is a diagram illustrating simulation results of reflection characteristics of the second port in the simulation patterns C and M illustrated in FIG. 3. FIG. 12 is a diagram illustrating simulation results of reflection characteristics of the first port in simulation patterns C, N, O, and P illustrated in FIG. 3.

As illustrated in FIG. 3, the first capacitor C1 has 0.033 [μF] and the second capacitor C2 has 0.01 [μF] in the patterns M, N, O, and P. That is, in the patterns M, N, O, and P, the first capacitor C1 and the second capacitor C2 have the same respective values as those in the pattern C.

In the pattern M, the first inductor L1 (the inductors L11, L12, and L13) and the second inductor L2 (the inductors L21, L22, and L23) are short-circuited. That is, the case is assumed where power is directly supplied from the first power supply circuit 12 to the signal transmission path and power is directly supplied to the second power supply circuit 22 via the signal transmission path.

In the pattern N, the first inductor L1 (the total inductance value of the inductors L11, L12, and L13) and the second inductor L2 (the total inductance value of the inductors L21, L22, and L23) have 47 [μH].

In the pattern O, the first inductor L1 (the total inductance value of the inductors L11, L12, and L13) and the second inductor L2 (the total inductance value of the inductors L21, L22, and L23) have 22 [μH].

In the pattern P, the first inductor L1 (the total inductance value of the inductors L11, L12, and L13) and the second inductor L2 (the total inductance value of the inductors L21, L22, and L23) have 10 [μH].

As illustrated in FIG. 11A, in the reflection characteristics of the first port P1 at frequencies of 1 [MHz] to 10 [MHz], that is, the reflection characteristics at frequencies of 1 [MHz] to 10 [MHz] focused in the present disclosure, a frequency range in which the gain of −30 [dB] is obtained is limited to a frequency range of approximately 3 [MHz] or higher in the pattern M in which the first inductor L1 (the inductors L11, L12, and L13) and the second inductor L2 (the inductors L21, L22, and L23) are short-circuited. Like the reflection characteristics of the first port P1 at frequencies of 1 [MHz] to 10 [MHz], the reflection characteristics of the second port P2 at frequencies of 1 [MHz] to 10 [MHz] are deteriorated as illustrated in FIG. 11B. That is, the transmission system 100 illustrated in FIG. 1 is assumed to include the PoC circuit 13 including the first inductor L1 (the inductors L11, L12, and L13) and a PoC circuit 23 including the second inductor L2 (the inductors L21, L22, and L23).

As illustrated in FIG. 12, in the reflection characteristics at frequencies of 1 [MHz] to 10 [MHz] focused in the present disclosure, the gain of −30 [dB] is obtained as represented by a dash-dot line in FIG. 12 in the pattern N illustrated in FIG. 3 in which the first inductor L1 (the total inductance value of the inductors L11, L12, and L13) and the second inductor L2 (the total inductance value of the inductors L21, L22, and L23) have 47 [μH].

As illustrated in FIG. 12, in the reflection characteristics at frequencies of 1 [MHz] to 10 [MHz] focused in the present disclosure, a frequency range in which the gain of −30 [dB] is obtained is a frequency range of approximately 2.5 [MHz] or higher as represented by a dash-dot-dot line in FIG. 12 in the pattern O illustrated in FIG. 3 in which the first inductor L1 (the total inductance value of the inductors L11, L12, and L13) and the second inductor L2 (the total inductance value of the inductors L21, L22, and L23) have 22 [μH].

On the other hand, as illustrated in FIG. 12, in the reflection characteristics at frequencies of 1 [MHz] to 10 [MHz] focused in the present disclosure, a frequency range in which the gain of −30 [dB] is obtained is limited to a narrow range around 4 [MHz] and a narrow range around 10 [MHz] as represented by the solid line in FIG. 12 in the pattern P illustrated in FIG. 3 in which the first inductor L1 (the total inductance value of the inductors L11, L12, and L13) and the second inductor L2 (the total inductance value of the inductors L21, L22, and L23) have 10 [μH].

Accordingly, it is desired that the inductance values of the first inductor L1 and the second inductor L2 be in the range from 20 [μH] to 50 [μH].

Thus, in the transmission system 100 according to Embodiment 1, the capacitance value of the first capacitor C1 is set in the range of 0.022 [μF] or greater, the capacitance value of the second capacitor C2 is set in the range from 0.0068 [μF] to 0.01 [μF], and the inductance values of the first inductor L1 and the second inductor L2 are set in the range from 20 [μH] to 50 [μH]. As a result, in the configuration in which the transmission speed of a signal from the first circuit module 1 to the second circuit module 2, that is, the transmission speed of a signal from the first interface IC 11 to the second interface IC 21 is relatively low transmission speed of 1 [MHz] to several tens of [MHz], reflection characteristics at frequencies of 1 [MHz] to 10 [MHz] focused in the present disclosure can be improved on the first interface IC 11 side, that is, at the first port P1.

Accordingly, transmission characteristics in a relatively low frequency range, specifically, transmission characteristics at relatively low transmission speeds of, for example, 1 [MHz] to several tens of [MHz], in particular, reflection characteristics on a transmission side (the first circuit module 1, that is, the first interface IC 11), can be improved without increasing the inductance value of the first inductor L1 included in the PoC circuit 13 and the inductance value of the second inductor L2 included in the PoC circuit 23. This can contribute to saving the space of the first circuit module 1 and the second circuit module 2. In addition, the value of a rated current that can pass the signal transmission path in the transmission system 100 can be increased.

### Embodiment 2

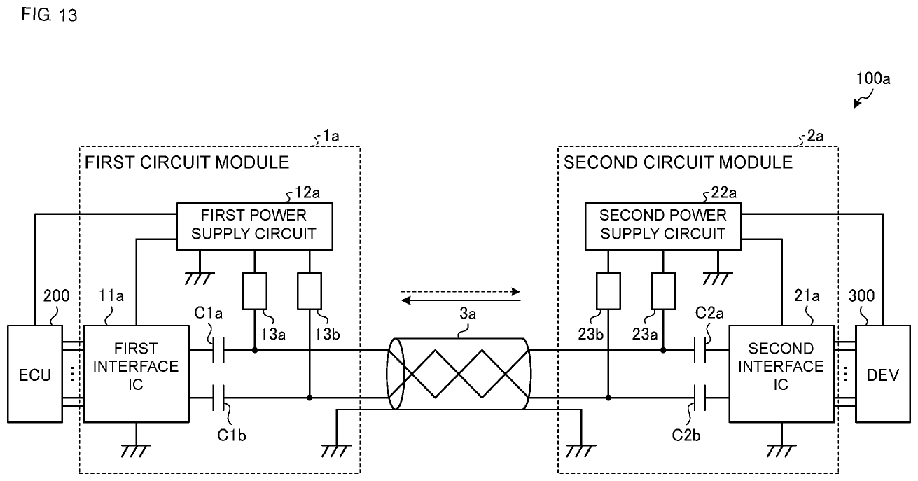

FIG. 13 is a diagram illustrating the schematic configuration of a transmission system according to Embodiment 2.

In a transmission system 100a according to the present embodiment, a differential signal is transmitted between a first circuit module 1a and a second circuit module 2a that are connected by a wire 3a including a twisted wire pair as illustrated in FIG. 13.

The transmission system 100a enables PoDL (Power over Data Lines) by applying a direct voltage to a signal transmission path and supplying power to the DEV 300 via the wire 3a.

A first interface IC 11a converts a signal input from the ECU 200 into a differential signal and outputs the differential signal to the second circuit module 2a via the twisted wire pair in the wire 3a. The first interface IC 11a converts a differential signal input via the twisted wire pair in the wire 3a and outputs the converted signal to the ECU 200.

A second interface IC 21a converts a differential signal input via the twisted wire pair in the wire 3a and outputs the converted signal to the DEV 300. The second interface IC 21a converts a signal input from the DEV 300 into a differential signal and outputs the differential signal to the first circuit module 1a via the twisted wire pair in the wire 3a.

A first power supply circuit 12a supplies power to, for example, the first interface IC 11a and the ECU 200 and also supplies power to the signal transmission path via PoDL circuits 13a and 13b. A second power supply circuit 22a receives power supplied from the signal transmission path via PoDL circuits 23a and 23b and supplies power to, for example, the second interface IC 21a and the DEV 300. The PoDL circuits 13a and 13b correspond to the PoC circuit 13 in Embodiment 1, and the PoDL circuits 23a and 23b correspond to the PoC circuit 23 in Embodiment 1. First capacitors C1a and C1b correspond to the first capacitor C1 in Embodiment 1. Second capacitors C2a and C2b correspond to the second capacitor C2 in Embodiment 1.

The configuration described in Embodiment 1 of the present disclosure can be applied to the configuration according to Embodiment 2 illustrated in FIG. 13. In particular, the configuration according to Embodiment 2 illustrated in FIG. 13 has a substantial advantage in saving the space of the first circuit module 1a and the second circuit module 2a by reducing the size of the first inductors L1 included in the PoDL circuits 13a and 13b and the size of the second inductors L2 included in the PoDL circuits 23a and 23b.

The embodiments described above are intended to help easily understand the present disclosure and are not to be used to construe the present disclosure in a limiting fashion. The present disclosure may be modified or improved without departing from the gist thereof, and equivalents of such modifications or improvements are also included in the present disclosure.

The present disclosure can have the following configuration as described above or instead of the above description.

(1) A transmission system according to an aspect of the present disclosure is configured to superimpose power on a transmission path for a signal between a first circuit module and a second circuit module. The transmission system includes a first capacitor provided between the transmission path and a first interface IC in the first circuit module, a second capacitor provided between the transmission path and a second interface IC in the second circuit module, a first inductor provided between a first power supply circuit in the first circuit module and the transmission path, and a second inductor provided between a second power supply circuit in the second circuit module and the transmission path. A capacitance value of the first capacitor and a capacitance value of the second capacitor differ from each other. An inductance value of the first inductor and an inductance value of the second inductor are in a range from 20 [μH] to 50 [μH].

With this configuration, transmission characteristics in a low frequency range can be improved and size reduction can be achieved.

(2) In the transmission system according to (1) described above, one of the first capacitor and the second capacitor preferably has a capacitance value of 0.02 [μF] or greater, and another one of the first capacitor and the second capacitor preferably has a capacitance value in a range from 0.0068 [μF] to 0.01 [μF].

(3) In the transmission system according to (1) or (2) described above, the transmission path may be a coaxial cable.

(4) In the transmission system according to (1) or (2) described above, the transmission system may include transmission paths each of which is the transmission path for a signal between the first circuit module and the second circuit module.

(5) In the transmission system according to (4), the transmission path may be a wire including a differential twisted wire pair.

(6) In the transmission system according to (1), the first capacitor preferably has a larger capacitance value than the second capacitor.

(7) In the transmission system according to (1), the capacitance value of the first capacitor is preferably greater than or equal to 0.02 [μF] and the capacitance value of the second capacitor is preferably in a range from 0.0068 [μF] to 0.01 [μF].

According to the present disclosure, a transmission system capable of improving transmission characteristics in a low frequency range and achieving size reduction can be provided.

What is claimed is:

1. A transmission system configured to superimpose power on a transmission path for a signal between a first circuit module and a second circuit module, the transmission system comprising:
a first capacitor between the transmission path and a first interface IC in the first circuit module;
a second capacitor between the transmission path and a second interface IC in the second circuit module;
a first inductor between a first power supply circuit in the first circuit module and the transmission path; and
a second inductor between a second power supply circuit in the second circuit module and the transmission path, wherein
a capacitance value of the first capacitor and a capacitance value of the second capacitor differ from each other, and
an inductance value of the first inductor and an inductance value of the second inductor are in a range from 20 [μH] to 50 [μH].

2. The transmission system according to claim 1, wherein
one of the first capacitor and the second capacitor has a capacitance value of 0.02 [μF] or greater, and
another one of the first capacitor and the second capacitor has a capacitance value in a range from 0.0068 [μF] to 0.01 [μF].

3. The transmission system according to claim 1, wherein
the transmission path is a coaxial cable.

4. The transmission system according to claim 1, wherein
the transmission system comprises transmission paths each of which is the transmission path for a signal between the first circuit module and the second circuit module.

5. The transmission system according to claim 4, wherein
the transmission path is a wire including a differential twisted wire pair.

6. The transmission system according to claim 1, wherein the first capacitor has a larger capacitance value than the second capacitor.

7. The transmission system according to claim 1, wherein
the capacitance value of the first capacitor is greater than or equal to 0.02 [μF], and the capacitance value of the second capacitor is in a range from 0.0068 [μF] to 0.01 [μF].

8. The transmission system according to claim 2, wherein
the transmission path is a coaxial cable.

9. The transmission system according to claim 2, wherein
the transmission system comprises transmission paths each of which is the transmission path for a signal between the first circuit module and the second circuit module.

10. The transmission system according to claim 9, wherein
the transmission path is a wire including a differential twisted wire pair.
